(19) United States
(12) Patent Application Publication
(10) Pub. No.: US 2020/0304317 A1
(43) Pub. Date: Sep. 24, 2020

(54) SECURE FILE

(71) Applicants: BRAD G. RICHCREEK, Bonaire, GA (US); JOSEPH GRANT TOMPKINS, Kathleen, GA (US); DON K. NGUYEN, Warner Robins, GA (US); SCOTT TYLER MOORE, Colorado Springs, CO (US); ERIC JAMES MARUSA, Edmond, OK (US); CLINTON TYSON, Kathleen, GA (US)

(72) Inventors: BRAD G. RICHCREEK, Bonaire, GA (US); JOSEPH GRANT TOMPKINS, Kathleen, GA (US); DON K. NGUYEN, Warner Robins, GA (US); SCOTT TYLER MOORE, Colorado Springs, CO (US); ERIC JAMES MARUSA, Edmond, OK (US); CLINTON TYSON, Kathleen, GA (US)

(73) Assignee: NORTHROP GRUMMAN SYSTEMS CORPORATION, FALLS CHURCH, VA (US)

(21) Appl. No.: 16/359,744

(22) Filed: Mar. 20, 2019

(51) Int. Cl. H04L 9/32; H04L 9/30; G06F 21/62; G06F 21/60; H04L 9/08; H04L 29/06

(52) U.S. Cl. CPC H04L 9/3268; H04L 9/30; G06F 21/6218; H04L 63/0435; H04L 9/0861; H04L 9/3247; G06F 21/602

(57) ABSTRACT

A file server can receive a request from a client executing on an end-user device for access to a given file and a digital certificate assigned to a user. The file server can wrap content of the given file with a public key of the digital certificate assigned to the user to form wrapped content, such that content of the given file is accessible only with a private key corresponding to the public key of the digital certificate. The file server can also embed permissions for access to the given file and the wrapped content of the given file in a secure file and transmit the secure file to the client.

### TECHNICAL FIELD

The present disclosure relates to computer security. More particularly, this disclosure relates to a system and method for securely accessing a file.

### BACKGROUND

In cryptography, a digital certificate, also known as a public key certificate or identity certificate, is an electronic document used to prove the ownership of a public key. The digital certificate includes information about an included public key, information about the identity of the owner (called the subject) of the digital certificate, and a digital signature of an entity that has verified the certificate's contents (called the issuer). If the signature of the digital certificate is valid, and the software examining the certificate trusts the issuer, then the public key will communicate securely with the certificate's subject. In Transport Layer Security (TLS) a digital certificate's subject is typically a computer or other device, though TLS certificates may identify organizations or individuals in addition to their core role in identifying devices. TLS, sometimes called by its older name Secure Sockets Layer (SSL), is notable for being a part of the Hypertext Transfer Protocol Secure (HTTPS), a protocol for securely browsing the web.

A digital signature is a mathematical scheme for verifying the authenticity and integrity of digital messages or documents. A valid digital signature gives a recipient reason to believe that the message was created by a known sender (authentication), that the sender cannot deny having sent the message (non-repudiation), and that the message was not altered in transit (integrity). Digital signatures are a standard element of most cryptographic protocol suites, and are commonly used for software distribution, financial transactions, contract management software, and in other cases where it is important to detect forgery and/or tampering.

### SUMMARY

One example relates to a system for securely accessing a file including a non-transitory memory having machine executable instructions and a processing unit for accessing the machine readable instructions. The machine readable instructions includes a file server that receives a request from a client executing on an end-user device for access to a given file and a digital certificate assigned to a user. The file server also wraps content of the given file with a public key of the digital certificate assigned to the user to form wrapped content, such that content of the given file is accessible only with a private key corresponding to the public key of the digital certificate. The file server further embeds permissions to access the given file and the wrapped content of the given file in a secure file and transmits the secure file to the client.

Another example relates to a non-transitory machine readable medium having machine readable instructions, the machine readable instructions including a file viewer that receives a secure file from a client application, wherein the secure file includes wrapped content for a given file that is only accessible with a private key corresponding to a public key of a digital certificate assigned to a user. The file viewer can also unwrap the wrapped content of the secure file through employment of the private key corresponding to the public key of the digital certificate assigned to the end-user to reveal the content of the given file. The file viewer can further securely output the content of the given file to the end-user in unencrypted form.

Yet another example relates to a method of securely transferring a file. The method can include receiving a request from a client executing on an end-user device for access to a given file and a digital certificate assigned to a user. The method can also include wrapping content of the given file with a public key of the digital certificate assigned to the user to form wrapped content, such that the content of the given file is accessible only with a private key corresponding to the public key of the digital certificate. The method can further include embedding permissions to access the given file and the wrapped content of the given file in a secure file and transmitting the secure file to the client.

### BRIEF DESCRIPTION OF THE DRAWINGS

FIG. 1 illustrates an example of a system that securely transfers and controls access to a file.

FIG. 2 illustrates an example of a server that securely transfers a file.

FIG. 3 illustrates a diagram of an example of a secure file.

FIG. 4 illustrates an example of an end-user device that access a secure file.

FIG. 5 illustrates a flowchart of example method for securely transferring and controlling access to a file.

FIG. 6 illustrates a flowchart of an example method for wrapping a file with a public key of a digital certificate assigned to a user of an end-user device.

### DETAILED DESCRIPTION

The present disclosure relates to systems and methods for securely transferring and controlling access to a given (selected) file. The system can include a file server that receives a request from a client executing on an end-user device for access to a given file and a digital certificate assigned to a user. In response, the file server wraps content of the given file with a public key of the digital certificate assigned to the user to form wrapped content, such that the content of the given file is accessible only with a private key corresponding to the public key of the digital certificate. The file server embeds with permissions to access the given file and the wrapped content of the given file in a secure file and transmits the secure file to the client.

The client executing on an end-user device receives the secure file. Moreover, the end-user device executes a file viewer that unwraps the wrapped content of the secure file through employment of the private key corresponding to the public key of the digital certificate assigned to the end-user to reveal the content of the given file and securely outputs the content of the given file on the end-user device in unencrypted form. As an example, the secure outputting can be displaying unencrypted content of the given file on a display, and preventing the unencrypted content from being stored in non-volatile memory.

By employment of the systems and methods described herein, possession and/or access to the private key corresponding to the public key of the digital certificate assigned to the user is required each time the secure file is accessed. In this manner, the secure file cannot be accessed after an unauthorized transfer.

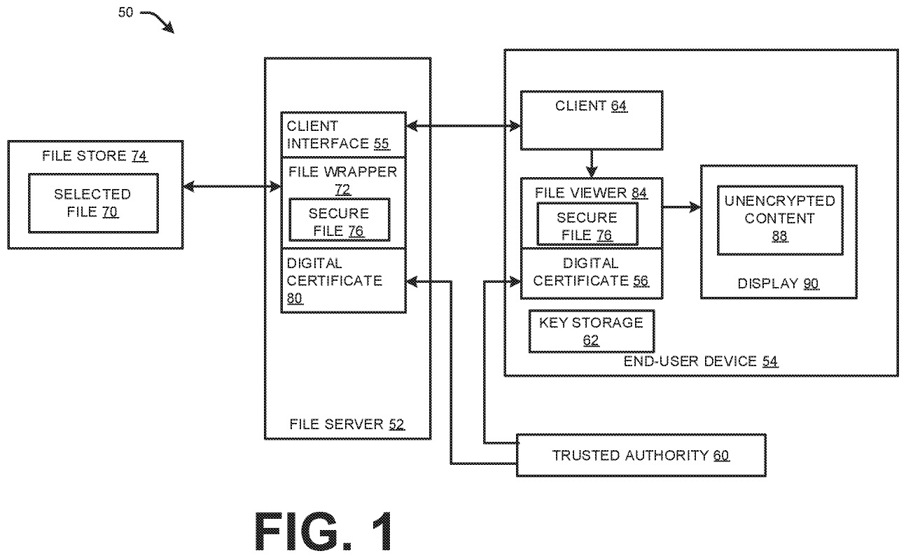

FIG. 1 illustrates an example of a system 50 for securely distributing a file and controlling access to contents of the file. As used herein, the term “file” could correspond to a single digital file or multiple digital files. Additionally, the file can be nearly any consumable file format, including but not limited to a portable document format (PDF) file, document (DOC) file, an Office Open XML (DOCX, PPTX, XLSX, etc.), a text file, etc.

The system 50 can include a file server 52 that can interact with an end-user device 54. The file server 52 can be implemented as a computing device with a client interface 55, such as a web interface and/or a proprietary interface (e.g., a document management system interface). The file server 52 could be implemented in a computing cloud. In such a situation, features of the file server 52 could be representative of a single instance of hardware or multiple instances of hardware with applications executing across the multiple of instances (i.e., distributed) of hardware (e.g., computers, routers, memory, processors, or a combination thereof). Alternatively, the file server 52 could be implemented on a single dedicated server.

The end-user device 54 can be implemented as a computing platform that can view and possibly edit documents. As some examples, the end-user device 54 can be implemented as a desktop computer, a laptop computer a mobile device (e.g., a smart phone, a tablet computer, etc.). The end-user device 54 can include a digital certificate 56 (alternatively referred to as a public key certificate) that has been issued by a trusted authority 60. The digital certificate 56 can be assigned to a user of the end-user device 54 by the trusted authority 60. The digital certificate 56 includes a digital signature of the trusted authority 60.

The digital certificate 56 includes a public key of a public/private key pair. Thus, the public key of the digital certificate 56 can be employed to encrypt data that can be decrypted only by the private key of public/private key pair. The private key of the digital certificate 56 is stored in a key storage 62. FIG. 1 illustrates the key storage 62 as being stored on the end-user device 54. In some examples, the key storage 62 can be stored in a local memory of the end-user device 54, such as a tamper-resistant partition of the local memory of the end-user device 54. In other examples, the key storage 62 can be a secure memory location, such as memory on a trusted platform module (TPM) installed on the end-user device 54. In still other examples, the key storage 62 could be external to the end-user device 54, such as a secure memory partition on an identification (ID) badge assigned to the user and physically carried by the user.

The digital signature of the trusted authority 60 is employable to verify the authenticity and integrity of the digital certificate 56 assigned to the user of the end-user device 54. Accordingly, a recipient of the digital certificate 56 can employ the digital signature of the trusted authority 60 to ensure that the digital certificate 56 originated from a trusted source and that the digital certificate 56 has not been modified since the signature was generated.

The end-user device 54 can include a client 64 that is employable to access the client interface 55 of the file server 52. In some examples, the client 64 can be implemented as a web browser. In other examples, the client 64 can be a proprietary software application. As one example, the client interface 55 operates in concert with the client 64 to provide a graphical user interface (GUI) for the user of the end-user device 54.

In one example, it is presumed that the user of the end-user device 54 provides requisite user authentication to the client interface 55 via the client 64. Upon authenticating the user, the client 64 selects a file 70 (“selected file”) in response to user input at the client 64, and the client 64 provides a request for the selected file 70. The request can include, for example, a copy of the digital certificate 56 for the user.

In response, the client interface 55 can forward the request to a file wrapper 72. The file wrapper 72 can be implemented as backend software that process requests for files. The file wrapper 72 can employ the signature in the digital certificate 56 of the user to verify the identity of the user. Upon validating the digital certificate 56, the file wrapper can query a file store 74 for the selected file 70. The query can include, information characterizing the user (e.g., extracted from the digital certificate) as well as information identifying the selected file 70. The file store 74 could be, for example, a document management system. Moreover, in some examples, the file store 74 can be integrated with the file server 52. In other examples, the file store 74 can be implemented on a separate server.

The file server 52 can return the selected file 70 along with a list of permissions for the user that is assigned the digital certificate 56. The file wrapper 72 can prepare a secure file 76 based on the selected file 70 and the list of permissions assigned to the user that is assigned the digital certificate 56.

To generate the secure file 76, the file wrapper 72 can employ a digital certificate 80 assigned to the file server 52 to generate a digital signature for the selected file 70. The digital certificate 80 can be issued by the trusted authority 60, which can be the same or different trusted authority as the trusted authority 60 that issued the digital certificate 56 for the end-user device 54.

Additionally, the file wrapper 72 can generate a symmetric key and encrypt the contents of the selected file 70 with the symmetric key to form encrypted content for the secure file 76. Further, the file wrapper 72 can embed information characterizing the permissions granted to the user that is assigned the digital certificate 56 in the secure file 76. Further still, the file wrapper can embed the digital signature of the content of the selected file 70 to the secure file 76.

The symmetric key can be implemented as an Advanced Encryption Standard (AES) key. Moreover, the file wrapper 72 can encrypt the symmetric key generated for the secure file with the public key of the digital certificate 56 assigned to the user of the end-user device 54 and embed the encrypted symmetric key in the secure file 76. Accordingly, the symmetric key is only decryptable with the private key corresponding to the public key of the digital certificate 56 assigned to the user. In this manner, the content of the secure file 76 is “wrapped” in the public key of the digital certificate 56 assigned to the user.

The secure file 76 can be provided to the client 64. The client 64 can forward the secure file 76 to a file viewer 84 executing on the end-user device 54. The file viewer 84 is programmed/configured such that each time the user desires to access the secure file 76, the file viewer 84 unwraps wrapped content of the secure file 76 to reveal the contents of the secure file 76 to the user of the end-user device 54. Additionally, the file viewer 84 can enforce the permissions embedded in the secure file 76.

To unwrap the contents of the secure file 76, the file viewer 84 extracts the encrypted symmetric key and leverages the private key of the key storage 62 to decrypt the symmetric key. As noted, in some examples, the key storage 62 can be embedded in a discrete device with a secure cryptoprocessor, such as a TPM or an ID badge. In such a situation the file viewer 84 can forward the encrypted symmetric key to the secure cryptoprocessor along in a request for decryption. In response, the secure cryptoprocessor returns the decrypted symmetric key to the file viewer 84.

Upon decrypting the symmetric key, the file viewer 84 can employ the (unencrypted) symmetric key to decrypt the remaining components of the secure file 76. More particularly, the file viewer 84 can decrypt the encrypted content of the selected file 70 and retrieve embedded information that characterizes the permissions for the user that is assigned the digital certificate 56. Further, the file viewer 84 can employ the digital signature to verify the authenticity and integrity of the unencrypted contents of the selected file 70.

The file viewer 84 can output unencrypted content 88 on a display 90. In some examples, the display 90 can be a standard display, such as a desktop or a laptop monitor. In other examples, the display 90 can be a touch-screen display, such a display on a smart phone or tablet computer.

The permissions for the secure file 76 can specify that unencrypted content of the secure file 76 is not permitted to be stored in non-volatile memory and/or transferred to another computing device. In such a situation, the file viewer 84 can be configured/programmed such that the unencrypted content 88 is output on the display 90, and the unencrypted content 88 and the unencrypted symmetric key is stored only in volatile memory of the end-user device 54. Further, the permissions embedded in the secure file 76 may specify that the unencrypted content 88 is not to be printed. In such a situation, the file viewer 84 is configured/programmed to prevent efforts of printing the unencrypted content 88. Similarly, the permissions embedded in the secure file 76 may specify that screenshots of the display 90 with the unencrypted content 88 are not permitted. In such a situation, the file viewer 84 can disable screenshots of the display 90 while the unencrypted content 88 is output.

The file viewer 84 can remove the unencrypted content 88 from the display 90 in response to user input characterizing a desire to close the secure file 76. Additionally, in some examples, the file viewer 84 can clear the volatile memory of the data for the unencrypted content 88 to prevent unauthorized transfer of information. Furthermore, each time the user desires to access the secure file 76, the file viewer 84 re-unwraps the secure file 76 in the same manner.

In some examples, the secure file 76 can be stored in an unsecured area and transferred to another computing device. However, in such a situation, the other computing device would not be able to access the contents of the selected file 70 unless the other computing device possessed or otherwise had access to the private key corresponding to the public key of the digital certificate 56 assigned to the user. Further, in contrast to conventional password protected file, it would be futile of the user of the end-user device 54 to pass verbal or written information (e.g., a password) to another user of the other computing platform, since such a password would not enable the other user to unwrap the content of the secure file 76 without the access to the private key corresponding to the public key of the digital certificate 56 assigned to the user. Accordingly, even if the secure file 76 is transferred to an unauthorized user (e.g., through malware), the unauthorized user would not be able to access the content of the selected file 70.

By employment of the system 50, an entity (e.g., a government or business) improves the security deployable to the files stored at the file store 74, including the selected file 70. Furthermore, the system 50 avoids the security hole created by a standard password protected file. Further still, the secure file 76 is self-contained. Accordingly, there is no requirement for the end-user device 54 to communicate with an external server to access the secure file 76. Rather, to access the secure file 76, the file viewer 84 needs possession of or access to the private key corresponding to the public key of the digital certificate 56 assigned to the user of the end-user device 54.

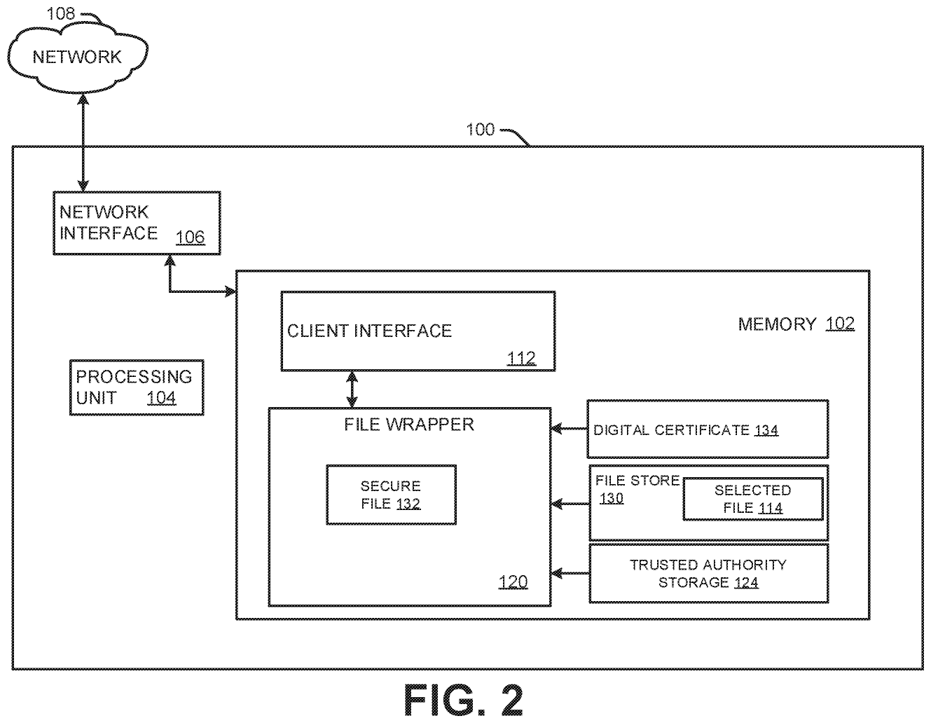

FIG. 2 illustrates an example of a file server 100 that could be employed to implement the file server 52 in FIG. 1. The file server 100 can include a memory 102 that can store machine readable instructions. The memory 102 could be implemented, for example, as non-transitory machine readable media, such as volatile memory (e.g., random access memory), nonvolatile memory (e.g., a hard disk drive, a solid state drive, flash memory, etc.) or a combination thereof. The file server 100 can also include a processing unit 104 to access the memory 102 and execute the machine-readable instructions. The processing unit 104 can include, for example, one or more processor cores. The file server 100 can include a network interface 106 configured to communicate with a network 108. The network interface 106 could be implemented, for example, as a network interface card. The network 108 could be implemented for example, as a public network (e.g., the Internet), a private network (e.g., proprietary network), or a combination thereof (e.g., a virtual private network).

The file server 100 could be implemented, for example in a computing cloud. In such a situation, features of the file server 100, such as the processing unit 104, the network interface 106, and the memory 102 could be representative of a single instance of hardware or multiple instances of hardware with applications executing across the multiple of instances (i.e., distributed) of hardware (e.g., computers, routers, memory, processors, or a combination thereof). Alternatively, the file server 100 could be implemented on a single dedicated server.

The memory 102 can include a client interface 112 that is programmed/configured to communicate with a client operating on an end-user device (e.g., the end-user device 54 of FIG. 1) via the network 108. In some examples, the client interface 112 establishes a secure channel with the end-user device, such as an HTTPS session. The client interface 112 can be implemented, for example, as a web server that provides a web page for the client. In other examples the client interface 112 can be a proprietary interface.

A client executing on the end-user device can provide a select a file from a menu provided by the client interface 112, which can be referred to as a selected file 114. The request can include a digital certificate assigned to a user of the end-user device.

In response, the client interface 112 can provide a file wrapper 120 stored in the memory 102 with the request for the selected file 114. The file wrapper 120 can analyze the digital certificate assigned to the user of the end-user device to verify the authenticity and integrity of a public key embedded in the digital certificate assigned to the user of the end-user device.

More particularly, in one example, the digital certificate assigned to the end-user of the end-user device can include a digital signature and an identity (e.g., a website address) of the issuer, namely a trusted authority. The trusted authority securely stores a trusted authority's private key of an asymmetric encryption key pair (sometime referred to simply as a “key pair”). The file wrapper 120 can examine a trusted authority storage 124 of the memory 102 to determine if the trusted authority is known and trusted. If the trusted authority is not known, the file wrapper 120 can contact the trusted authority via the network 108 and request a copy of the public key of the trusted authority. If the trusted authority is known, the trusted authority storage 124 can store a copy the public key of the trusted authority that has been previously retrieved.

The public key of the trusted authority is employable to decrypt data encrypted with the private key of the trusted authority. In some examples, the digital certificate assigned to the user of the end-user device also includes an encrypted version of a hash of the public key (the hash may also be referred to as a message digest) and a plaintext version of the public key of the digital certificate assigned to the user. The encrypted version of the hash of the public key has been encrypted with the private key of the trusted authority. A hash function employed to generate the hash of the public key can be stored in the trusted authority storage 124.

In some examples, the file wrapper 120 can decrypt the encrypted version of the hash of the public key of the digital certificate assigned to the user using the public key of the trusted authority to form a decrypted hash. Additionally, the file wrapper 120 can execute the hash function on the public key of the digital certificate assigned to the user and compare the results of the hash to the decrypted hash to verify the authenticity and integrity of the digital certificate assigned to the user of the end-user device.

Upon verifying the authenticity and integrity of the digital certificate, the file wrapper 120 can retrieve the selected file 114 from a file store 130. The file store 130 can return the selected file 114 along with a list of permissions related to the selected file 114 for the user (identified by the digital certificate).

The file wrapper 120 can generate a secure file 132 corresponding to the selected file 114 based on the digital certificate assigned to the user of the end-user device. The secure file 132 includes wrapped content that can be unwrapped through employment of the private key corresponding to the public key of the digital certificate. To generate the secure file 132, the file wrapper 120 generates a symmetric key (e.g., an AES key) for the selected file 114. The file wrapper 120 employs the symmetric key to encrypt the content of the selected file 114. Furthermore, the file wrapper 120 generates a digital signature for the content of the selected file and the permissions for the user (returned by the file store 130) based on a digital certificate 134 of the file server 100 that is issued by a trusted authority. Further still, the file wrapper 120 encrypts the symmetric key with the public key of the certificate assigned to the user of the end-user device.

The file wrapper 120 embeds the encrypted symmetric key, the encrypted content of the selected file 114, the permissions for the user, and the signature of the content of the file into the secure file 132 to form the wrapped content of the secure file 132. The encrypted symmetric key is decryptable only with the private key corresponding to the public key of the certificate issued to the user, and the (decrypted) symmetric key is employable to decrypt the remaining portions of the secure file 132. In this manner, the content of the secure file 132 (including the content of the selected file 114) is wrapped with the public key of the certificate issued to the user.

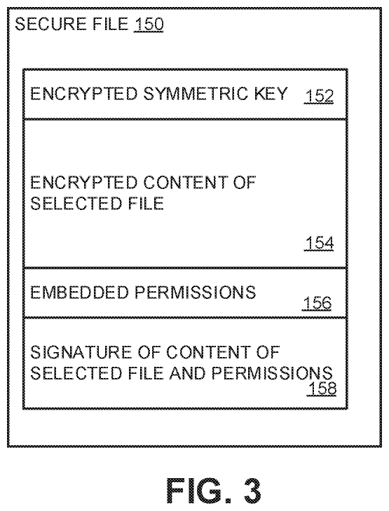

FIG. 3 illustrates a diagram of an example of a secure file 150 that could be generated by the file wrapper 120. The secure file includes “wrapped content”, namely content that is only accessible directly or indirectly through employment of a private key corresponding to a public key of a digital certificate assigned to a user. The secure file 150 includes an encrypted symmetric key 152 and encrypted content of a selected file 154. The secure file 150 also includes embedded permissions 156 that characterize permissions of access to decrypted content of the selected file. The secure file 150 further includes a digital signature (e.g., of the file server 100) of content of the selected file and the permissions 158 that is employable to verify the authenticity and integrity of the selected file.

Referring back to FIG. 2, upon generating the secure file 132, the file wrapper 120 provides the client interface 112 with the secure file 132. The client interface 112 forwards the secure file 132 to the end-user device via the network 108 in response to the request for the selected file. The end-user device can access the contents of the selected file in a manner described herein.

By employment of the file server 100, an entity (e.g., a government or business) improves the security deployable to the files stored at the file store 130, including the selected file 114. Furthermore, the file server 100 avoids the security hole created by a standard password protected file since the private key corresponding to the public key of the digital certificate assigned to the user is required to access the contents of the selected file 114.

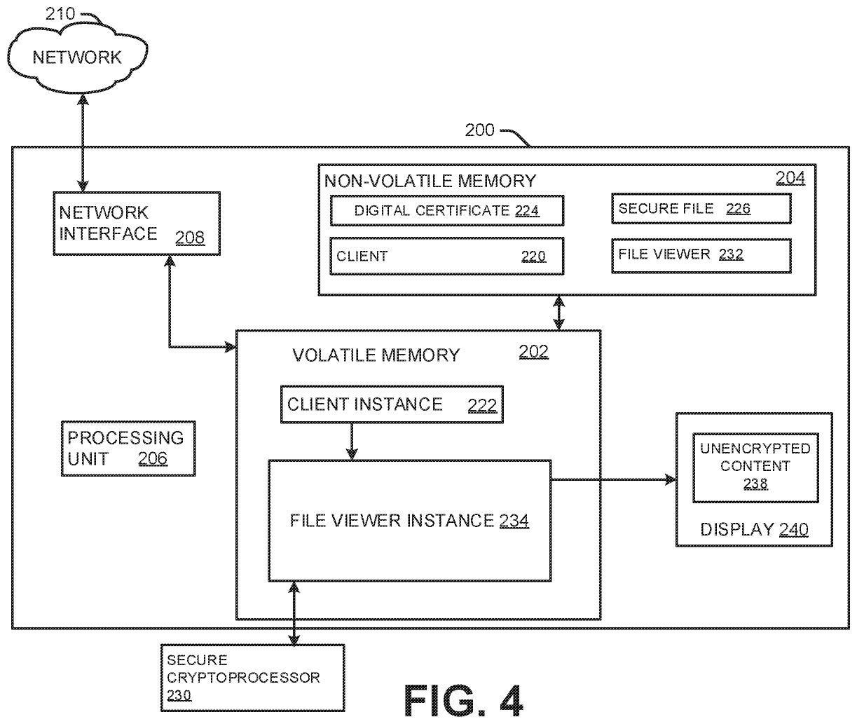

FIG. 4 illustrates an example of an end-user device 200 that could be employed to implement the file server 52 in FIG. 1. The end-user device 200 includes explicit illustration of two types of non-transitory memory, namely volatile memory 202 and non-volatile memory 204. The volatile memory 202 can be representative of a non-transitory machined readable medium random access memory (RAM) that stores data and machine executable instructions at times that the end-user device 200 is powered on. Moreover, the volatile memory 202 is cleared each time the end-user device 200 is powered-off or reset. The non-volatile memory 204 can be representative of non-transitory long-term memory, such as a solid state drive (SSD), a hard disk drive (HDD), flash memory, etc. The non-volatile memory 204 can store data and machine readable instructions in times when the end-user device is powered-off or reset.

The end-user device 200 can also include a processing unit 206 that can access the non-volatile memory 204 to move machine readable instructions from the non-volatile memory 204 to the volatile memory 202, where the processing unit 206 accesses the volatile memory 202 and execute the machine-readable instructions stored in the volatile memory 202. The processing unit 206 can include, for example, one or more processor cores. The end-user device 200 can include a network interface 208 configured to communicate with a network 210. The network interface 208 could be implemented, for example, as a network interface card. The network 210 could be implemented for example, as a public network (e.g., the Internet), a private network (e.g., proprietary network) or a combination thereof (e.g., a virtual private network).

The non-volatile memory 204 can include a client 220 that can be implemented as a web browser or a proprietary program for communicating with a client interface of a file server (e.g., the file server 52 of FIG. 1 and/or the file server 100 of FIG. 2) via the network 210. The processing unit 206 can load an instance of the client 220 into the volatile memory to execute a client instance 222 (e.g., an instance of the client 220 being executed on a computing platform).

The client instance 222 can operate in concert with the client interface of the file server to request a selected file via a secure connection (e.g., an HTTPS session). The request can include a copy of a digital certificate 224 that is stored in the non-volatile memory 204. The digital certificate 224 can be issued by a trusted authority (e.g., the trusted authority 60 of FIG. 1) and is assigned to a user of the end-user device 200. The digital certificate 224 includes a public key embedded therein.

In the example illustrated, a private key corresponding to the public key of the digital certificate 224 can be stored on a cryptoprocessor 230. The cryptoprocessor 230 is illustrated as being external to the end-user device 200. However, in other examples, the cryptoprocessor 230 may be integrated with the end-user device 200, such as in a discrete component (e.g., a TPM chip). In examples where the cryptoprocessor 230 is external to the end-user device 200, the cryptoprocessor 230 could be implemented on an ID badge physically carried by the user of the end-user device 200 that communicates with the end-user device 200 via near field communication (NFC).

In response to the request for the selected file, the client instance 222 receives a secure file 226 from the file server via the network 210. The secure file 226 is stored in the non-volatile memory and the secure file 226 includes content wrapped with the public key of the digital certificate 224. To unwrap the wrapped content of the secure file 226, the processing unit 206 can load an instance of a file viewer 232 stored in the non-volatile memory 204 to provide a file viewer instance 234 executing on a computing platform.

The viewer instance 234 can retrieve the secure file 226 from the volatile memory 204 and unwrap the secure file 226 to reveal content of the selected file. The secure file 226 can be implemented in a manner similar to the secure file 150 of FIG. 3. To unwrap the wrapped content of the secure file 226, the file viewer instance 234 can extract an encrypted symmetric key embedded in the secure file 226. As explained herein, the encrypted symmetric key was encrypted with the public key of the digital certificate 224 assigned to the user of the end-user device 200.

The file viewer instance 234 can cause decryption of the encrypted symmetric key through employment of the private key corresponding to the public key of the digital certificate 224 assigned to the user. More specifically, to cause the decryption, the file viewer instance can forward the encrypted symmetric key along with a request for decryption to the cryptoprocessor 230. In response, the cryptoprocessor 230 can employ the private key corresponding to the public key of the digital certificate 224 to decrypt the encrypted symmetric key to reveal an unencrypted symmetric key. The cryptoprocessor 230 can return the unencrypted symmetric key to the file viewer instance 234.

The file viewer instance 234 can employ the (unencrypted) symmetric key to decrypt other components of the secure file. In particular, the file viewer instance 234 can employ the symmetric key to decrypt encrypted content of the selected file and retrieve embedded permissions for the selected file that are embedded in the secure file 232. Furthermore, the file viewer instance 234 can employ a digital signature of the content of the selected file to verify the authenticity and integrity of the content of the selected file.

The file viewer instance 234 can output the unencrypted content 238 of the selected file on a display 240. In some examples, the display 240 can be a standard display, such as a desktop or laptop monitor. In other examples, the display 240 can be a touch-screen display, such as a display on a smart phone or tablet computer. The unencrypted content 238 can be user consumable information, such as, but not limited to, text, audio, pictures, charts, etc. The unencrypted content 238 varies based on a file type of the selected file.

The permissions for the secure file 226 can specify that unencrypted content of the secure file 226 is not permitted to be stored in non-volatile memory. In such a situation, the file viewer instance 234 can be configured/programmed such that the unencrypted content 238 is output on the display 240, and the unencrypted content 238 is stored only in the volatile memory 202 of the end-user device 200. Similarly, the unencrypted symmetric key is only permitted to be stored in the volatile memory 202. Further, the permissions embedded in the secure file 226 may specify that the unencrypted content 238 is not to be printed. In such a situation, the file viewer instance 234 is configured/programmed to prevent efforts of printing the unencrypted content 238. Similarly, the permissions embedded in the secure file 226 may specify that screenshots of the display 240 with the unencrypted content 238 are not permitted. In such a situation, the file viewer instance 234 can disable screenshots of the display 240 while the unencrypted content 238 is output.

The file viewer instance 234 can clear the unencrypted content 238 of the selected file from the display 240 in response to user input characterizing a desire to close the secure file 226, such as selecting a “close window” virtual button. Additionally, in some examples, the file viewer instance 234 can clear the volatile memory 202 of the data for the unencrypted content 238 to prevent unauthorized transfer of information. Furthermore, each time the user desires to access the secure file 226, the file viewer instance 234 (or another instance thereof) re-unwraps the secure file 226 in the same manner.

In some examples, the secure file 226 can be stored in an unsecured area and transferred to another computing device. However, in such a situation, the other computing device would not be able to access the contents of the selected file 70 unless the other computing device possessed or otherwise had access to the private key corresponding to the public key of the digital certificate 224 assigned to the user. Further, in contrast to conventional password systems, the user of the end-user device 54 would be unable to pass verbal or written information (e.g., a password) to a user of the other computing platform that would permit access to the contents of the selected file 70. Accordingly, even if the secure file 76 is transferred to an unauthorized user (e.g., through malware), the unauthorized user would not be able to access the content of the selected file 70.

The secure file 226 is self-contained. Accordingly, there is no requirement for the end-user device 200 to communicate with an external server to unwrap the contents of the secure file 226. Rather, to unwrap the contents the secure file 226, the file viewer instance 234 needs possession of or access to the private key corresponding to the public key of the digital certificate 224 assigned to the user of the end-user device 200. In this manner, unauthorized transfer of the selected file (embedded in the secure file 226) is prevented without.

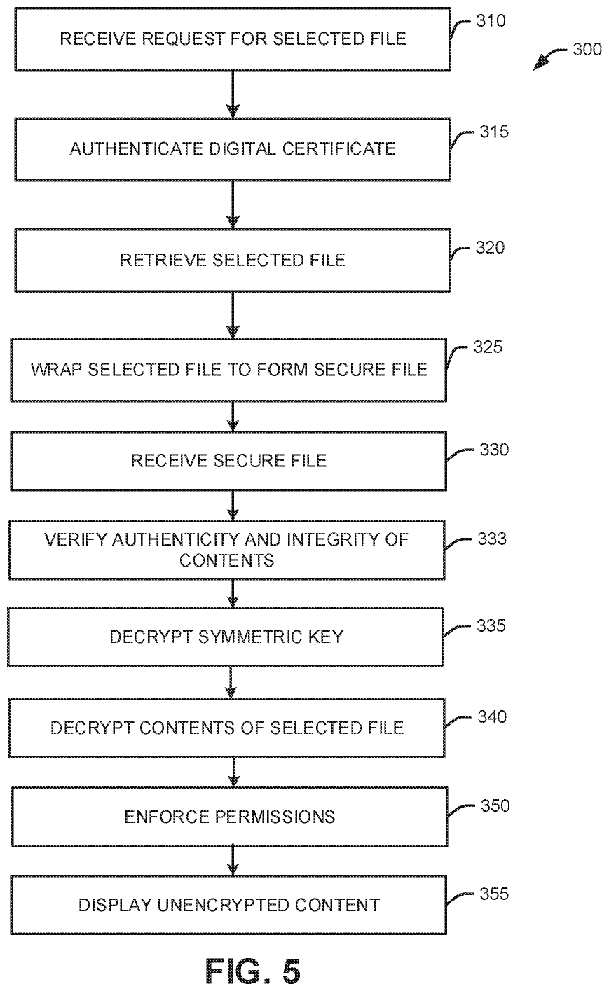

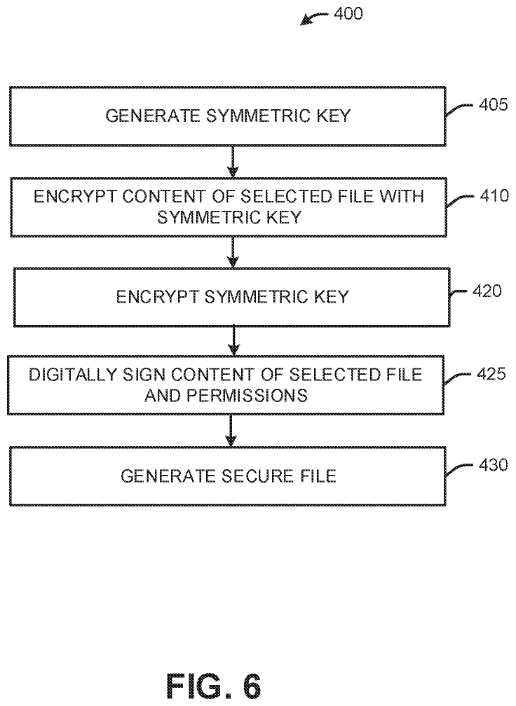

In view of the foregoing structural and functional features described above, example methods will be better appreciated with reference to FIGS. 5 and 6. While, for purposes of simplicity of explanation, the example methods of FIGS. 5 and 6 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example methods of FIGS. 5 and 6 can be implemented as instructions stored in a non-transitory machine-readable medium. The instructions can be accessed by a processing resource (e.g., one or more processor cores) and executed to perform the methods disclosed herein.

FIG. 5 illustrates an example of a method 300 for securely transferring a file and controlling access to the file. The method 300 can be implemented, for example, by the system 50 of FIG. 1, the file server 100 of FIG. 2 and/or the end-user device 200 of FIG. 4.

At 310, a client interface (e.g., the client interface 55 of FIG. 1) receives a request for a selected file from a client operating on an end-user device. The request includes a copy of a digital certificate assigned to the user of the end-user device. At 315, a file wrapper (e.g., the file wrapper 72 of FIG. 1) authenticates the digital certificate to verify the authenticity and integrity of the digital certificate assigned to the user of the end-user device. At 320, the file wrapper retrieves the selected file from a file store (e.g., the file store 74 of FIG. 1). The file store returns the selected file along with a list of permissions for the user that is assigned the digital certificate.

At 325, the file wrapper wraps the selected file with the public key of the digital certificate assigned to the user to form a secure file with wrapped content. FIG. 6 illustrates a sub-method 400 for executing the wrapping at 325 of FIG. 5. At 405, the file wrapper can generate a symmetric key for the selected file. At 410, the file wrapper can encrypt content of the selected file with the symmetric key. At 420, the file wrapper can encrypt the symmetric key with the public key of the digital certificate assigned to the user of the end user device. At 425, the contents of the selected file and list of permissions for accessing the selected file can be digitally signed by the file wrapper with a digital certificate of the file server. At 430, a secure file is generated by embedding the encrypted symmetric key, the encrypted contents of the selected file, the permissions for accessing the secure file and the digital signature of the selected file into the secure file.

Returning to FIG. 5, at 330, the secure file is received at a file viewer executing on the end-user device such that the file viewer can unwrap wrapped content of the secure file. At 333, the file wrapper can employ the digital signature embedded in the secure file to verify the authenticity and integrity of the contents of the selected file. At 335, the symmetric key is decrypted with the private key corresponding to the public key of the digital certificate assigned to the user of the end-user device. In some examples, the decryption can be executed by a cryptoprocessor external to the end-user device (e.g., embedded in an ID badge). In other examples, the decryption can be executed by a component integrated with the end-user device, such as a TPM. In still other examples, the decryption can be executed by the file wrapper.

At 340, the file wrapper can employ the decrypted symmetric key to decrypt the encrypted contents of the selected file. At 350, the file viewer enforces the permissions embedded in the secure file, such as preventing the unencrypted contents and the decrypted symmetric key from being stored in non-volatile memory at 355, the file viewer displays the unencrypted contents of the selected file on a display, presuming that the permissions enforced at 350 allow such a display.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A system for securely accessing a file comprising:
a non-transitory memory having machine executable instructions; and
a processing unit for accessing the machine readable instructions, the machine readable instructions comprising:
a file server that:
receives a request from a client executing on an end-user device for access to a given file and a digital certificate assigned to a user;
wraps content of the given file with a public key of the digital certificate assigned to the user to form wrapped content, such that content of the given file is accessible only with a private key corresponding to the public key of the digital certificate;
embeds permissions for access to the given file and the wrapped content of the given file in a secure file; and
transmits the secure file to the client.

2. The system of claim 1, wherein the file server verifies the authenticity and integrity of the digital certificate prior to transmitting the secure file to the end-user device.

3. The system of claim 1, wherein the wrapping comprises:
generating a symmetric key for the given file;
encrypting the content of the given file with the symmetric key to form encrypted content; and
encrypting the symmetric key with the public key of the digital certificate assigned to the user to form an encrypted key, wherein the wrapped content comprises the encrypted content, and the encrypted key.

4. The system of claim 3, wherein the file server further:
generates a signature for the given file with a digital certificate of the file server; and
embeds the signature for the given file in the secure file.

5. The system of claim 4, wherein the end-user device comprises:
another non-transitory memory having machine executable instructions; and
another processing unit for accessing the machine readable instructions, the machine readable instructions of the other non-transitory memory comprising:
the client that receives the secure file; and
a file viewer that:
unwraps the wrapped content of the secure file through employment of the private key corresponding to the public key of the digital certificate assigned to the user of the end-user device to reveal the content of the given file; and
securely outputs the content of the given file on the end-user device in unencrypted form.

6. The system of claim 5, wherein the file viewer further verifies the content of the given file with the signature embedded in the secure file.

7. The system of claim 5, wherein the unwrapping comprises:
causing decryption of the symmetric key through employment of the private key corresponding to the public key of the digital certificate assigned to the user of the end-user device; and
decrypting the encrypted content of the wrapped content using the decrypted symmetric key.

8. The system of claim 5, wherein the secure outputting by the file viewer prevents transferring content of the given file in unencrypted form to another end-user device.

9. The system of claim 5, wherein the secure outputting by the file viewer prevents printing content of the given file in unencrypted form.

10. The system of claim 5, wherein the secure outputting by the file viewer prevents screen captures of content of the given file in unencrypted form.

11. The system of claim 5, wherein the secure outputting by the file viewer comprises outputting the content of the given file in unencrypted form on a display.

12. The system of claim 5, wherein the secure file is transferrable to another device and the secure file requires that the other device has access to the private key corresponding to the public key of the digital certificate assigned to the end-user to reveal the content of the given file.

13. A non-transitory machine readable medium having machine readable instructions, the machine readable instructions comprising:
a file viewer that:
receives a secure file from a client application, wherein the secure file comprises wrapped content for a given file that is only accessible with a private key corresponding to a public key of a digital certificate assigned to a user;
unwraps the wrapped content of the secure file through employment of the private key corresponding to the public key of the digital certificate assigned to the end-user to reveal the content of the given file; and
securely outputs the content of the given file to the end-user in unencrypted form.

14. The medium of claim 13, wherein the secure file further comprises:
a symmetric key that is encrypted with the public key of the digital certificate assigned to the user, wherein the wrapped content comprises content of the given file that has been encrypted with the symmetric key.

15. The medium of claim 14, wherein the unwrapping comprises:
causing decryption of the symmetric key through employment of the private key corresponding to the public key of the digital certificate assigned to the end-user; and
decrypting the encrypted content of the wrapped content using the decrypted symmetric key to reveal the content of the given file in unencrypted form.

16. The medium of claim 14, wherein the secure file further comprises:
a signature for the given file signed with a digital certificate of a file server.

17. The medium of claim 14, wherein the unwrapping comprises:
causing decryption of the symmetric key through employment of the private key corresponding to the public key of the digital certificate assigned to the end-user;
decrypting the encrypted content of the wrapped content using the decrypted symmetric key to reveal the content of the given file in unencrypted form; and
verifying the authenticity and integrity of the content of the given file unencrypted form with the signature of the secure file and the digital certificate of the file server.

18. The medium of claim 13, wherein the secure outputting comprises:
preventing the content of the given file in unencrypted form from being stored in non-volatile memory.

19. A method of securely transferring a file comprising:
receiving a request from a client executing on an end-user device for access to a given file and a digital certificate assigned to a user;
wrapping content of the given file with a public key of the digital certificate assigned to the user to form wrapped content, such that the content of the given file is accessible only with a private key corresponding to the public key of the digital certificate;
embedding permissions for access to the given file and the wrapped content of the given file in a secure file; and
transmitting the secure file to the client.

20. The method of claim 19, wherein the method further comprises:
generating a signature for the given file with a digital certificate of the file server; and
embedding the signature for the given file in the secure file;
wherein the wrapping further comprises:
generating a symmetric key for the given file;
encrypting the content of the given file with the symmetric key to form encrypted content; and
encrypting the symmetric key with the public key of the digital certificate assigned to the user to form an encrypted key, wherein the wrapped content comprises the encrypted content and the encrypted key.
